(19) United States
(12) Patent Application Publication
(10) Pub. No.: US 2007/0179969 A1
(43) Pub. Date: Aug. 2, 2007

(54) Method of managing knowledge within an organization

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,900

(22) Filed: Jan. 29, 2007

Related U.S. Application Data
(60) Provisional application No. 60/762,514, filed on Jan. 27, 2006.

(51) Int. Cl. G06F 7/00

(52) U.S. Cl. 707/102

(57) ABSTRACT

A method of managing knowledge within an organization includes defining a three-dimensional data visualization structure of the organization, including interconnections between organizational elements of the organization in three dimensions. The three-dimensional data visualization structure of the organization includes first data relating to knowledge that is associated with a first organizational element. In particular, the first data is stored such that the first data is correlated with the three-dimensional data visualization structure of the organization. Second data associated with a knowledge requirement is mapped onto the three-dimensional data visualization structure of the organization, and the mapped second data is processed according to a known set of rules. When the mapped second data correlates with the first data, an indication is provided relating to one of the first organizational element and the first data itself.

This application claims the benefit of U.S. Provisional Application 60/762,514, filed on Jan. 27, 2006, the entire contents of which are incorporated herein by reference.

### FIELD OF THE INVENTION

The present invention relates generally to the storage and display of correlated data, and more particularly to a method of managing knowledge within an organization.

### BACKGROUND

Data storage, analysis, retrieval and display have always been important aspects of computers. Although different data retrieval and data display models have been proposed over the years, most system designers return to one of three models due to their simplicity, ease of use, and user comprehensibility. These three models include the desktop model, the list based model, and the hierarchical list model.

The desktop model was popularized by Apple® with its Macintosh® computers, and is used to display computer operating system data in a virtual desktop environment. On a computer screen is shown an image of a two-dimensional desktop with files, folders, a trashcan, and so forth being represented by different icons that are arranged in some manner on the “surface” of the desktop. To access files that are stored on the computer system, a user simply selects an appropriate icon from the desktop display. Though the desktop model is convenient and intuitive, it is often difficult to implement due to system level constraints. For example, the Windows® operating system that is provided by Microsoft® Corporation has limitations on file name length and, as such, is sometimes unable to store files sufficiently deeply within nested folders to truly reflect the desktop based model. Further, since some systems are more limited than others, the model when implemented results in some limitations on portability. For many applications and for application execution, the desktop model is often poor.

Also, though the desktop model is well suited to providing user references for many different functions, it is poorly suited for organizing large volumes of data since it has no inherent organizational structure other than the one that is set by a user. Thus, similar to actual physical desktops, some virtual desktops are neat and organized while others are messy and disorganized. Thus, for data organization and retrieval, the virtual desktop model is often neutral—neither enhancing nor diminishing a user's organizational skills.

The list-based model is employed in all aspects of daily life. Music organization programs display music identifiers such as titles and artists in a list that is sortable and searchable based on many different criteria. Typically, sort criteria are displayed as column headers allowing for easy searching based on the column headers. Many applications support more varied search criteria and search definition.

Another example of list based data display is Internet search engines, which typically show a list of results for a provided search query. The results are then selectable for navigating to a World Wide Web Site relating to the listed result. Unfortunately, with the wide adoption of the World Wide Web and with significant attempts to get around search engine technology—to “fool” the search engines—it is often difficult to significantly reduce a search space given a particular query. For example, the search term “fingerprint” returns a significant number of results for biometric based fingerprinting similar to that used by police and a significant number of results for genetic fingerprinting using DNA. These results are distinct one from another.

The hierarchical list is similar to the list-based model but for each element within a higher-level list, there exist further sub-items at a lower level. Thus, a first set of folders allows for selection of a folder having within it a set of subfolders, etc. This allows for effective organization of listed data. In the above noted music list program example, classical music can be stored in a separate sub list from country music, etc.

Some complex data structures, such as for instance the organizational charts of large corporations, or of other similarly organized bodies such as for instance government or military units, consist of interconnected and highly correlated nodes. For instance, hierarchal organization charts of a large corporation include typically a separate chart for each different unit of the corporation, with individuals and/or departments in each unit being represented as separate nodes in the chart, and with relationships between the separate nodes in the chart being shown as interconnections in two-dimensions. That said, it is often the case that relationships exist between individuals and/or departments in different units of the corporation, and accordingly the nodes of one chart actually are interconnected with the nodes of one or more of the other charts. Furthermore, it is often the case that different types of relationships exist between the nodes, such as for instance reporting relationships, communication relationships, financial relationships, etc. Unfortunately, current methods for analyzing and visualizing such highly correlated sets of data do not produce results that are intuitive to the user, and as a result the analysis is cumbersome and prone to errors and the visualization is confusing and prone to omissions. Often, this leads to a situation in which one person or department is not aware of what is being done within other portions of the organization. Time and effort is wasted repeating the successes, or repeating the failures, of other individuals or departments within the organization.

It would be advantageous to provide a method for analyzing and/or visualizing highly correlated data sets that overcomes at least some of the above-mentioned limitations of the prior art.

### SUMMARY OF EMBODIMENTS OF THE INSTANT INVENTION

According to an aspect of the instant invention there is provided a method of managing knowledge within an organization, comprising: defining a three-dimensional data visualization structure of the organization including interconnections between organizational elements of the organization in three dimensions, and including first data relating to knowledge associated with a first organizational element, the first data being stored such that the first data is correlated with the three-dimensional data visualization structure of the organization; mapping second data associated with a knowledge requirement onto the three-dimensional data visualization structure of the organization; processing the mapped second data according to a known set of rules; and, when the mapped second data correlates with the first data, providing an indication relating to one of the first organizational element and the first data.

According to an aspect of the instant invention there is provided a method of managing knowledge within an organization, comprising: providing a three-dimensional data visualization structure of the organization, the three-dimensional data visualization structure comprising data from N interconnected organizational charts distributed on a surface of at least one three-dimensional shapes, each one of the N organizational charts comprising a plurality of organizational elements, and at least some of the plurality of organizational elements in each one of the N organizational charts being interconnected with an organizational element in another one of the N organizational charts; storing, within the three-dimensional data visualization structure of the organization, first data relating to knowledge associated with at least some of the plurality of organizational elements, the first data stored such that different finite portions of the first data are correlated to different ones of at least some of the organizational elements; using a predetermined process, mapping second data associated with a knowledge requirement onto the three-dimensional data visualization structure of the organization for correlating the second data with a finite portion of the first data; and, providing an indication relating to one of an organizational element that is correlated with the finite portion of the first data and the finite portion of the first data.

According to an aspect of the instant invention there is provided a computer-readable storage medium having stored thereon computer-executable instructions for performing a method of managing knowledge within an organization, the method comprising: providing a three-dimensional data visualization structure of the organization, the three-dimensional data visualization structure comprising N organizational charts distributed on a surface of a three-dimensional shape, each one of the N organizational charts comprising a plurality of organizational elements, and at least some of the plurality of organizational elements in each one of the N organizational charts being interconnected with an organizational element in another of the N organizational charts; storing, within a three-dimensional data structure of the organization, first data relating to knowledge associated with at least some of the plurality of organizational elements, the first data stored such that different finite portions of the first data are correlated to different ones of the at least some of the organizational elements; using a deterministic process, mapping second data associated with a knowledge requirement onto the three-dimensional data visualization structure of the organization for correlating the second data with a finite portion of the first data; and, providing an indication relating to one of an organizational element that is correlated with the finite portion of the first data and the finite portion of the first data.

### BRIEF DESCRIPTION OF THE DRAWINGS

Exemplary embodiments of the invention will now be described in conjunction with the following drawings, in which similar reference numerals designate similar items:

FIG. 1 shows a simplified diagram of a three-dimensional data visualization structure in accordance with an embodiment of the instant invention;

FIG. 2 shows the three-dimensional data visualization structure of FIG. 1 after rotation;

FIG. 3a is a simplified schematic of an embodiment of the invention wherein the organization chart of an organization is displayed with overlays for management reporting as well as project reporting;

FIG. 3b shows a slice diagram relating to the organization;

FIG. 4 is a simplified flow diagram for a method of analyzing data relating to an organization according to an embodiment of the instant invention; and,

FIG. 5 is a simplified flow diagram for a method of analyzing data relating to an organization according to another embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

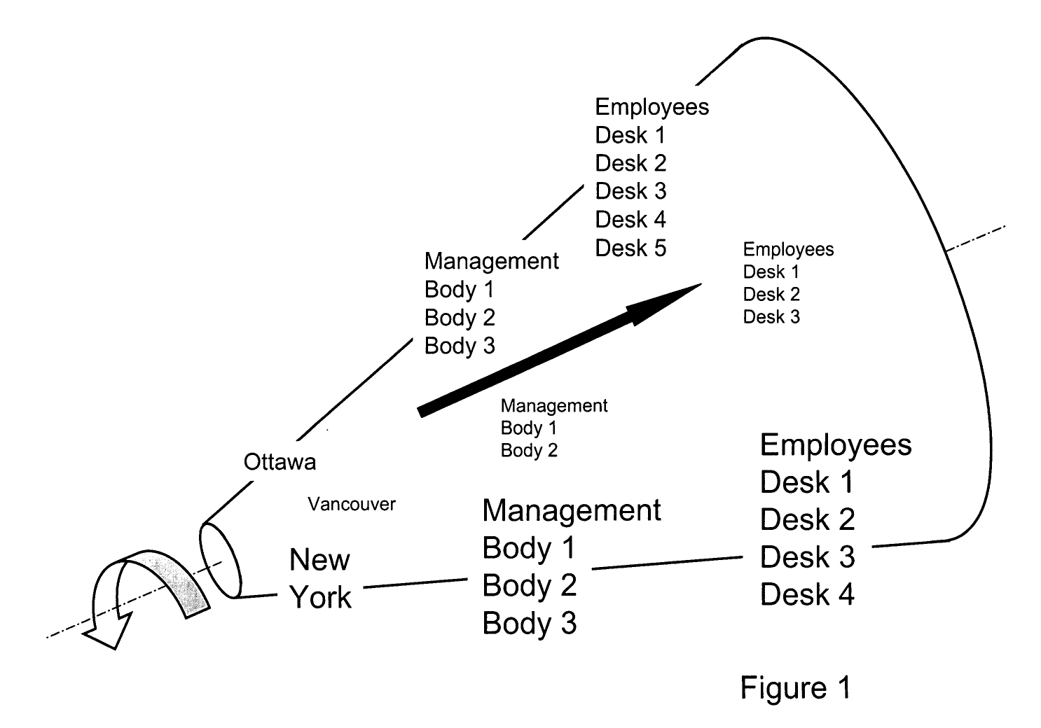

Referring to FIG. 1, shown is a three dimensional listing of organizational chart data relating to a corporation, or to another similarly organized body such as for instance a government department, a military unit, an aid agency, an educational institution, a retail chain, a transportation system, a volunteer association, a parts list, a manufacturers process, a patent, a supplier contract, a software application, etc. Any such organized body is referred to hereinafter simply as “the organization,” and the organizational charts associated therewith are referred to simply as “org charts.” In FIG. 1 the data is shown distributed on a surface of a three-dimensional cone for simplicity of discussion, though of course any of a number of other three-dimensional representations optionally is supported. For instance, optionally the three dimensional structure of the data being presented is spherical, a surface of a sphere, cubic, a surface of a cube, or is placed in accordance with another algorithm, manually, or randomly within a three dimensional or hierarchical three-dimensional space.

The org chart data that is shown in FIG. 1 represents a reporting org chart for the organization, or optionally for a portion thereof. In the instant example the data is sorted by office location (New York, Ottawa and Vancouver) around the cone and by hierarchal order within each office along a linear axis of the cone. Further, the New York office location is shown at the front of the cone (nearest the user) and the Vancouver office location is shown at the back of the cone (away from the user) with the Ottawa office location being shown at a position intermediate the New York and Vancouver office locations. As will be apparent, the size of the text font in FIG. 1 serves the purpose of providing a three-dimensional perspective, with text that is positioned closest to the user being the largest and text that is farthest away from the user being the smallest.

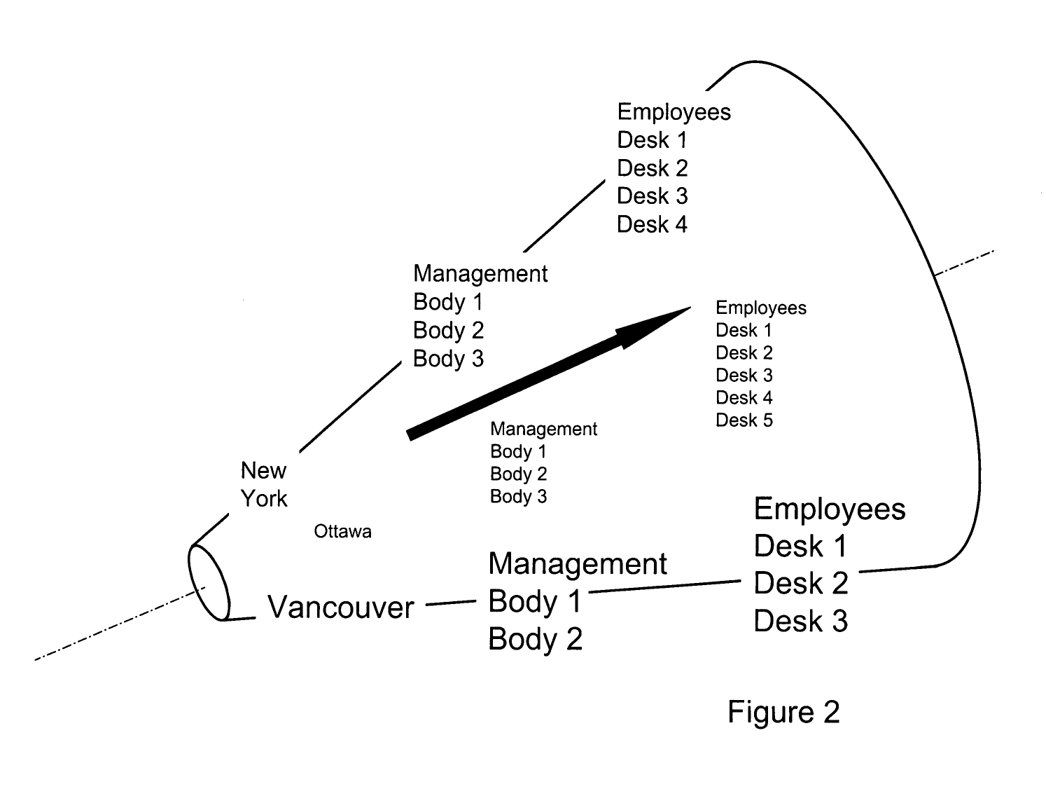

Due to the size of the organization, it is advantageous to utilize a three-dimensional data representation model in order to support convenient visualization of interconnections for reporting purposes, etc. Advantageously, the org chart so presented allows for moving of individuals within the organization. Of course individuals includes any individual entity within an organization, non limiting examples of which are a person, a department, a function, or a system. Furthermore, the org chart data is easily manipulated—rotated or traversed—to identify correlated data according to a user perspective. So for example, rotation of the cone in the direction that is shown in FIG. 1 brings the Vancouver office location forward as is shown in FIG. 2. The user optionally “drills in” or “drills out” to display other data that is correlated with any of the data shown in FIG. 2. Preferably, a process for coupling and decoupling of elements within the three dimensional view is provided for grouping of elements or for entering correlative data relating to different elements. Further preferably, viewing processes include navigation tools for rotating, translating, and navigating the three-dimensional view space.

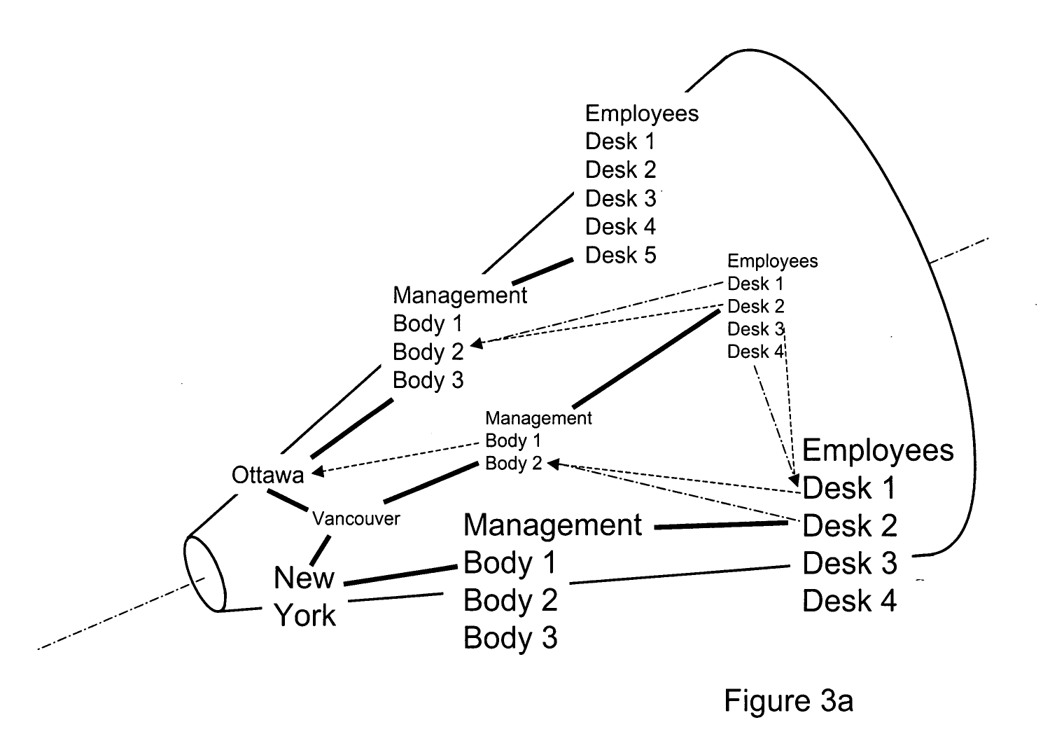

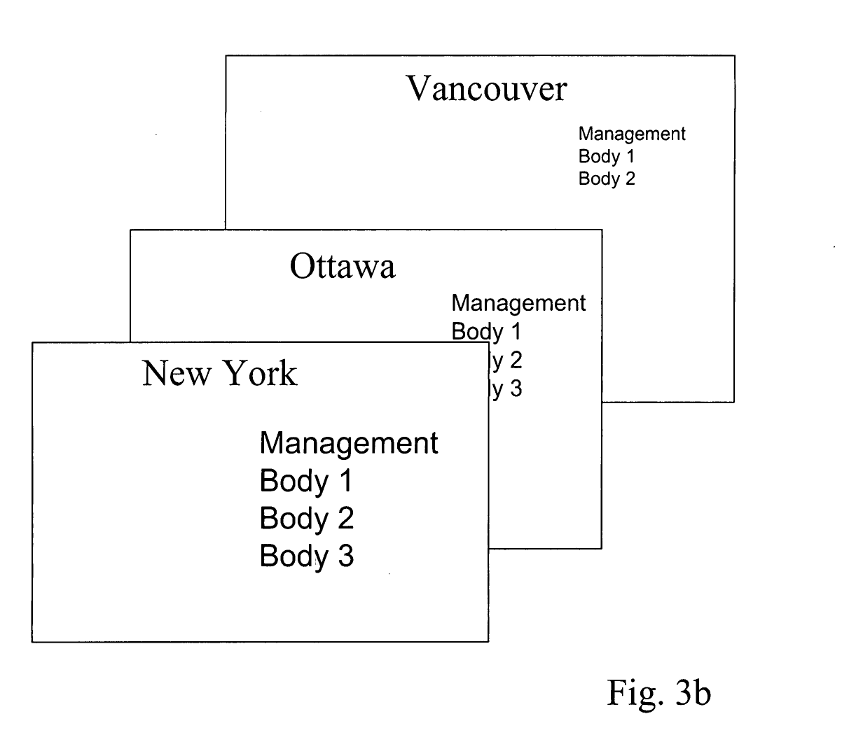

Referring to FIG. 3, shown is another three-dimensional listing of org chart data, highlighting a plurality of different interconnections including those of a communication org chart represented by dashed lines, those of a reporting org chart represented by solid lines and those of a project org chart represented by dotted lines. Here, reporting is performed on a functional basis, projects on a product basis, and communication via the legal, human resources, and communications departments. The different interconnects are shown between different slices of the organization, as is shown in FIG. 3b. Each slice is presented as a reporting org chart with the other org charts represented as interconnects between slices. By moving the slices, interconnections are both visible and more easily comprehended. Advantageously, a plurality of overlaid org charts provides many advantages. Firstly, corporate reorganizations are more easily viewed since, most often, they affect only reporting while retaining all other aspects of an organization. Secondly, managing information flow within an organization is facilitated since its flow for each distinct purpose is now mappable. Thirdly, by attributing to the interconnections rules, simulation of events and actual analysis of real events—business information analysis—become a real possibility.

Another form of org chart (not shown) relates to finances. These include financial reporting charts, revenue flow charts, cost propagation charts, financial approval org charts, and cash propagation charts for cash based businesses. By overlaying these on org charts and information charts, the amount of analysis performable increases dramatically while the visual nature of the chart remains functionally useful. Further, when the user is provided an opportunity to move blocks within the three-dimensional viewing space, it is possible to isolate blocks or groups of blocks while maintaining the rest of the organization. For example, a slice view of an organization of the information flow therethrough is provided. By moving some blocks, an additional slice is created for analysis, blocks within the slice relating to something being analyzed.

In each of the above examples interconnections are defined for correlating different org charts in three-dimensions, so as to provide a three-dimensional data visualization structure of the organization. Advantageously, the user has the ability to also define rules within the three-dimensional structure, such that data propagates within the three-dimensional structure in accordance with those rules. Thereafter, when data is mapped onto the three-dimensional structure the rules are applied such that the data “flows” through the organization.

One useful application, which is provided hereinbelow as a non-limiting example, relates to knowledge management within an organization. Referring again to FIG. 3, the organizational elements of the organization are labeled with data labels, such as for instance Body 1, Body 2, Body 3 at the management level and Desk 1, Desk 2, Desk 3, etc. at the individual or department level. In the instant example, it is assumed that an employee “Desk 1” of the Ottawa local office has, at some time in the past, performed a first task. For instance, the first task relates to analysis of a particular type of data, preparation of a particular type of report, procurement of a particular good or material, etc. Data relating to the completion of the first task is then stored in association with “Desk 1” within the multi-dimensional data visualization structure of the organization, which in this particular example is a three-dimensional structure. The data is correlated with the multi-dimensional data visualization structure of the organization, such as for example using keywords relating to the particular first task. The keywords optionally relate to the type of the first task, to a form that is completed in association with the first task, or to some other descriptive label, etc. The data is correlated with the multi-dimensional data visualization structure of the organization in such a way that it is interconnected with other data, which relates to for example similar tasks associated with other organizational elements or to other different tasks performed by other organizational elements in connection with the first task. In the former case, similar tasks include different instances of the first task being completed by different organizational elements at different times, and in the latter case the different tasks include other tasks performed as part of a larger project including the first task. In any case, the data associated with the first task and optionally other data of interest are stored in a fashion supporting visualization thereof within the multi-dimensional data visualization structure of the organization in such a way as to be retrievable at a later time.

Continuing with the same example, it is now assumed that at a later time a second employee “Desk 2” of the New York local office is assigned the first task. In view of the size of the organization as a whole, and the lack of a direct relationship between Desk 1 of the Ottawa local office and Desk 2 of the New York local office as shown in FIG. 3, it is highly unlikely that Desk 2 of the New York local office is aware of what Desk 1 of the Ottawa local office is doing at a current or earlier time. Although Desk 1 of the Ottawa local office has data relating to the first task stored in association therewith, this knowledge is not readily available to Desk 2 of the New York local office.

According to an embodiment of the instant invention, Desk 2 of the New York office provides data relating to the first task. The data is mapped onto the multi-dimensional data visualization structure of the organization, and the mapped data is processed according to a predetermined processing method. The result that is returned optionally is an indication relating to the organizational element Desk 1 of the Ottawa local office, or relating directly to the first task data that is stored in association with Desk 1 of the Ottawa local office. Of course, optionally any other first task data that is correlated with the data stored in association with Desk 1 of the Ottawa local office is returned as well. Further optionally, the first task data is parsed or otherwise formatted into the form of a suggestion as to how Desk 2 of the New York local office should proceed with the task, based upon how it was handled in the past.

As discussed supra the correlation optionally provides results that include elements of data, which are stored in association with other organizational elements. If for instance Desk 2 of the Ottawa local office has completed the same first task, or has completed a different task as part of a larger project including the first task, either in a cooperative manner around the same time, or independently at different times, etc., then data that is stored in association with Desk 2 of the. Ottawa local office optionally is also included in the result that is returned. Alternatively, the result of the correlation includes an indication of how not to handle the current first task, based upon past failed experiences with handling the first task. Optionally, the result of the correlation identifies other individuals or departments in the organizational structure that are either better suited to handle the first task, or that are at least competent to do so but that have more time available for competing the first task according to a known schedule. The correlation optionally flags redundancy within the organization, if for instance other individuals or departments are already working on the same first task, or flags other events that obviate the need to complete the first task at the current time, such as for instance providing an indication not to prepare an environmental assessment for a development in the event that a decision was made recently, but not communicated to the organizational element that is tasked with preparing the assessment, not to proceed at this time or at all with the development.

By correlating data relating to knowledge within the organization according to such a highly correlated multi-dimensional data visualization structure, it is possible to view the entire organization from a global perspective, rather than from a departmental or project perspective. Mapping data onto the multi-dimensional data structure makes data available beyond that which is normally available as a result of the established interconnections and relationships of different types between the organizational elements.

By way of a specific and non-limiting example, a method according to at least one of the embodiments of the instant invention is useful for auditing performance. Data relating to what should have happened if performance actually meets a threshold goal is mapped onto a multi-dimensional data visualization structure of an organization. In this context, the data relates to markers for non-performance, that is to say being indicative of performance not meeting the threshold goal. Advantageously, by defining rules for the interconnections between different nodes or organizational elements of the multi-dimensional data visualization structure the markers for non-performance need not relate to only one node at a time, in isolation from the rest of the organization. In other words, a global view relating to performance is obtainable. Optionally, rules are established relating to the interconnections and/or the nodes themselves. In this way, risks within the organization are identifiable. For example, too much return on investments is indicative of a risk that is too high given a known investment strategy, too little profit for the revenue generated is indicative of an overstaffing risk relative to revenue, etc.

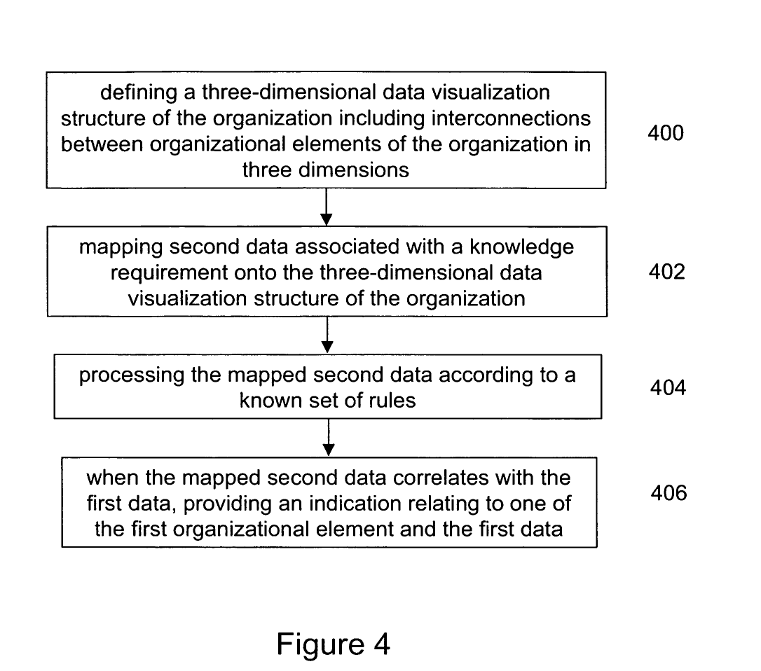

Referring now to FIG. 4, shown is a simplified flow diagram for a method of analyzing data relating to an organization according to an embodiment of the instant invention. At step 400 a three-dimensional data visualization structure of the organization is defined, including interconnections between organizational elements of the organization in three dimensions, and including first data relating to knowledge associated with a first organizational element. In particular, the first data is stored such that the first data is correlated with the three-dimensional data visualization structure of the organization. At step 402 second data associated with a knowledge requirement is mapped onto the three-dimensional data visualization structure of the organization. At step 404 the mapped second data is processed according to a known set of rules. At step 406, when the mapped second data correlates with the first data, an indication is provided relating to one of the first organizational element and the first data itself.

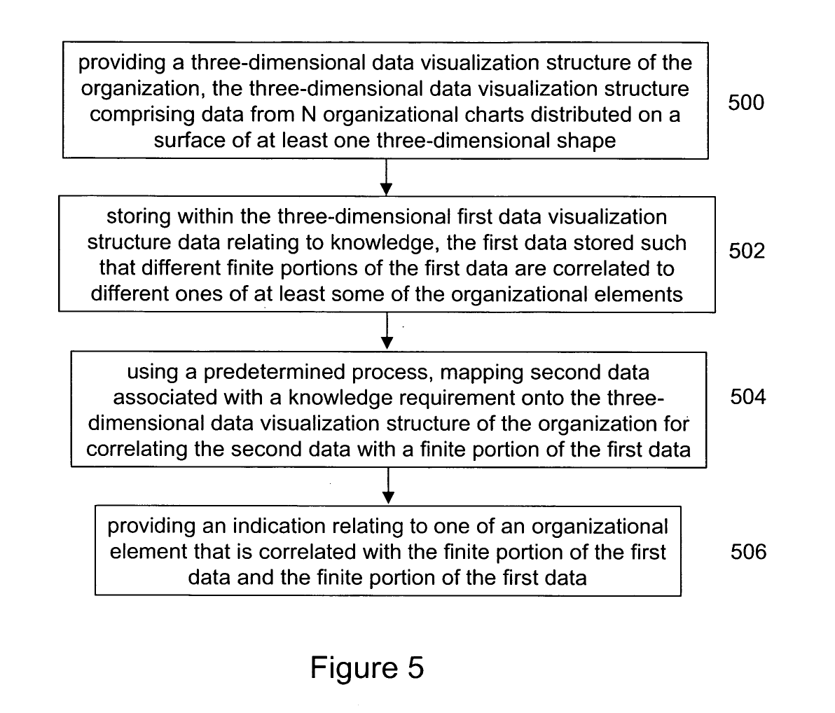

Referring now to FIG. 5, shown is a simplified flow diagram for a method of analyzing data relating to an organization according to another embodiment of the instant invention. At step 500 a three-dimensional data visualization structure of the organization is provided, the three-dimensional data visualization structure comprising N organizational charts distributed on a surface of a three-dimensional shape, each one of the N organizational charts comprising a plurality of organizational elements, and at least some of the plurality of organizational elements in each one of the N organizational charts being interconnected with an organizational element in another one of the N organizational charts. At step 502 first data relating to knowledge associated with at least some of the plurality of organizational elements is stored within the three-dimensional data visualization structure of the organization. In particular, the first data is stored such that different finite portions of the first data are correlated to different ones of the at least some of the organizational elements. At step 504, using a deterministic process, second data associated with a knowledge requirement is mapped onto the three-dimensional data visualization structure of the organization for correlating the second data with a finite portion of the first data. At step 506 an indication is provided relating to one of an organizational element that is correlated with the finite portion of the first data, and the finite portion of the first data itself.

Numerous other embodiments may be envisioned without departing from the spirit and scope of the invention.

What is claimed is:

1. A method of managing knowledge within an organization, comprising:
defining a three-dimensional data visualization structure of the organization including interconnections between organizational elements of the organization in three dimensions, and including first data relating to knowledge associated with a first organizational element, the first data being stored such that the first data is correlated with the three-dimensional data visualization structure of the organization;
mapping second data associated with a knowledge requirement onto the three-dimensional data visualization structure of the organization;
processing the mapped second data according to a known set of rules; and,
when the mapped second data correlates with the first data, providing an indication relating to one of the first organizational element and the first data.

2. A method according to claim 1 wherein a rule of the set of known rules relates to an organizational element of the organization.

3. A method according to claim 1 wherein a rule of the set of known rules relates to an interconnection within the three-dimensional data visualization structure of the organization.

4. A method according to claim 1 wherein an organizational element comprises one of an individual and a department within an organization.

5. A method according to claim 1 wherein an organizational element comprises a hierarchical structure, the hierarchical structure comprising a sub-organization comprising sub-organizational elements.

6. A method according to claim 1 wherein data flows through the structure of the organization in accordance with a plurality of rules associated with organizational elements and interconnections, the data flow performed in time steps wherein during a single time step rules are applied to data at a start of said time step and wherein during a subsequent time step rules are applied to data at an end of said time step.

7. A method according to claim 6 wherein in aggregate rules are applied to more than one organizational element in combination during a same time step.

8. A method according to claim 7 for use in processing of auditing data of a data flow through an organization.

9. A method according to claim 7 for use in simulating a data flow through an organization.

10. A method of managing knowledge within an organization, comprising:
providing a three-dimensional data visualization structure of the organization, the three-dimensional data visualization structure comprising data from N interconnected organizational charts distributed on a surface of at least one three-dimensional shapes, each one of the N organizational charts comprising a plurality of organizational elements, and at least some of the plurality of organizational elements in each one of the N organizational charts being interconnected with an organizational element in another one of the N organizational charts;
storing, within the three-dimensional data visualization structure of the organization, first data relating to knowledge associated with at least some of the plurality of organizational elements, the first data stored such that different finite portions of the first data are correlated to different ones of at least some of the organizational elements;
using a predetermined process, mapping second data associated with a knowledge requirement onto the three-dimensional data visualization structure of the organization for correlating the second data with a finite portion of the first data; and,
providing an indication relating to one of an organizational element that is correlated with the finite portion of the first data and the finite portion of the first data.

11. A method according to claim 10 wherein correlating the second data with a finite portion of the first data comprises processing the mapped second data according to a known set of rules.

12. A method according to claim 11 wherein a rule of the known set of rules relates to an organizational element of the organization.

13. A method according to claim 11 wherein a rule of the known set of rules relates to an interconnection within the three-dimensional data visualization structure of the organization.

14. A method according to claim 10 wherein an organizational element comprises one of an entity and a grouping of entities within an organization.

15. A method according to claim 10 wherein an organizational element comprises a hierarchical structure, the hierarchical structure comprising a sub-organization comprising sub-organizational elements.

16. A method according to claim 10 wherein data flows through the three-dimensional data visualization structure of the organization in accordance with a plurality of rules associated with the organizational elements and the interconnections there between, the data flow performed in time steps wherein during a single time step rules are applied to data at a start of said time step and wherein during a subsequent time step rules are applied to data at an end of said time step.

17. A method according to claim 16 wherein in aggregate rules are applied to more than one organizational element in combination during a same time step.

18. A method according to claim 17 for use in auditing of a data flow through an organization.

19. A method according to claim 17 for use in simulating a data flow through an organization.

20. A computer-readable storage medium having stored thereon computer-executable instructions for performing a method of managing knowledge within an organization, the method comprising:
providing a three-dimensional data visualization structure of the organization, the three-dimensional data visualization structure comprising N organizational charts distributed on a surface of a three-dimensional shape, each one of the N organizational charts comprising a plurality of organizational elements, and at least some of the plurality of organizational elements in each one of the N organizational charts being interconnected with an organizational element in another of the N organizational charts;
storing, within a three-dimensional data structure of the organization, first data relating to knowledge associated with at least some of the plurality of organizational elements, the first data stored such that different finite portions of the first data are correlated to different ones of the at least some of the organizational elements;
using a deterministic process, mapping second data associated with a knowledge requirement onto the three-dimensional data visualization structure of the organization for correlating the second data with a finite portion of the first data; and,
providing an indication relating to one of an organizational element that is correlated with the finite portion of the first data and the finite portion of the first data.
